(19) United States
(12) Patent Application Publication
(10) Pub. No.: US 2022/0199000 A1
(43) Pub. Date: Jun. 23, 2022

(54) PIXEL CIRCUIT SHARING DRIVING TRANSISTOR

(71) Applicant: InnoLux Corporation, Miao-Li County (TW)

(72) Inventors: Ker-Yih KAO, Miao-Li County (TW); Ming-Chun TSENG, Miao-Li County (TW); Kung-Chen KUO, Miao-Li County (TW); Yong-Zhi LIU, Miao-Li County (TW); Lien-Hsiang CHEN, Miao-Li County (TW)

(21) Appl. No.: 17/519,628

(22) Filed: Nov. 5, 2021

Related U.S. Application Data
(60) Provisional application No. 63/129,849, filed on Dec. 23, 2020.

(30) Foreign Application Priority Data
Aug. 12, 2021 (CN) 202110923552.X

(51) Int. Cl. G09G 3/32

(52) U.S. Cl. CPC G09G 3/32; G09G 2300/0842; G09G 2310/0275; G09G 2310/0267

(57) ABSTRACT

An electronic device includes a substrate, a first light emitting unit, a second light emitting unit, a driving transistor, a first emission transistor, and a second emission transistor. The first light emitting unit and the second light emitting unit are disposed on the substrate. The driving transistor is electrically connected to a voltage source. The first emission transistor is electrically connected between the driving transistor and the first light emitting unit. The second emission transistor is electrically connected between the driving transistor and the second light emitting unit.

### CROSS REFERENCE TO RELATED APPLICATIONS

This application claims the benefit of U.S. Provisional Application No. 63/129,849, filed on Dec. 23, 2020, and claims priority of China Patent Application No. 202110923552.X, filed on Aug. 12, 2021, the entirety of which are incorporated by reference herein.

### BACKGROUND OF THE INVENTION

### Field of the Invention

The disclosure is generally related to an electronic device and a pixel circuit thereof, and more particularly it is related to a pixel circuit sharing a driving transistor.

### Description of the Related Art

With the increasing popularity of high-resolution display panels, the space between the pixels in a display panel is getting smaller and smaller, and the area of the circuit layout is becoming more and more limited. In order to solve the problem of limited circuit layout area, it is necessary to optimize the pixel circuit.

### BRIEF SUMMARY OF THE INVENTION

In an embodiment, an electronic device is provided. The electronic device includes a substrate, a first light emitting unit, a second light emitting unit, a driving transistor, a first emission transistor, and a second emission transistor. The first light emitting unit and the second light emitting unit are disposed on the substrate. The driving transistor is electrically connected to a voltage source, the first emission transistor is electrically connected between the driving transistor and the first light emitting unit, and the second emission transistor is electrically connected between the driving transistor and the second light emitting unit.

A detailed description is given in the following embodiments with reference to the accompanying drawings.

### BRIEF DESCRIPTION OF DRAWINGS

The disclosure can be more fully understood by reading the subsequent detailed description and examples with references made to the accompanying drawings, wherein:

FIG. 1 is a schematic diagram of a pixel circuit in accordance with an embodiment of the disclosure;

FIG. 2 illustrates a transistor structure of a pixel circuit in accordance with an embodiment of the disclosure;

FIG. 3 illustrates a waveform diagram of the pixel circuit in FIG. 1 in accordance with an embodiment of the disclosure;

FIG. 4 is a schematic diagram of a pixel circuit in accordance with another embodiment of the disclosure;

FIG. 5 is a schematic diagram of a pixel circuit in accordance with another embodiment of the disclosure;

FIG. 6 is a schematic diagram of a pixel circuit in accordance with another embodiment of the disclosure;

FIG. 7 is a schematic diagram of a pixel circuit in accordance with another embodiment of the disclosure;

FIG. 8 illustrates a waveform diagram of the pixel circuit in FIG. 7 in accordance with an embodiment of the disclosure;

FIG. 9 illustrates a waveform diagram of the pixel circuit in FIG. 7 in accordance with another embodiment of the disclosure; and

FIG. 10 is a schematic diagram of a pixel circuit in accordance with another embodiment of the disclosure.

### DETAILED DESCRIPTION OF THE INVENTION

This description is made for the purpose of illustrating the general principles of the disclosure and should not be taken in a limiting sense. In addition, the present disclosure may repeat reference numerals and/or letters in the various examples. This repetition is for the purpose of simplicity and clarity and does not in itself dictate a relationship between the various embodiments and/or configurations discussed. The scope of the disclosure is best determined by reference to the appended claims.

It would be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It is understood that the following disclosure provides many different embodiments, or examples, for implementing different features of the application. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact.

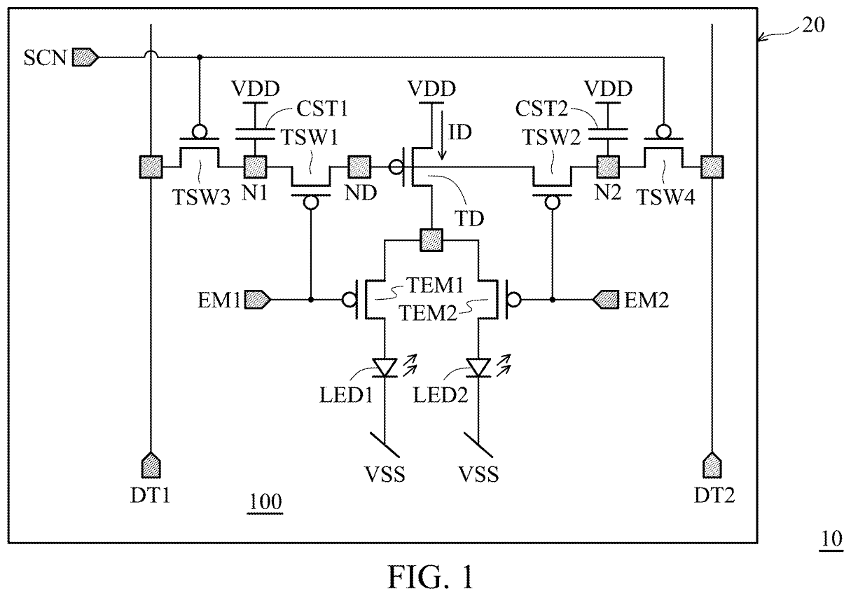

FIG. 1 is a schematic diagram of a pixel circuit in accordance with an embodiment of the disclosure. The electronic device in the disclosure may include a display device or may be any electronic device having a display panel, such as a touch display device, a curved display device, a flexible display device, or a free shape display device, but not intended to be limited thereto. As shown in FIG. 1, the electronic device 10 includes a pixel circuit 100 and a substrate 20, in which the pixel circuit 100 is formed on the substrate 20. As shown in FIG. 1, the pixel circuit 100 includes a first switch transistor TSW1, a first storage capacitor CST1, a second switch transistor TSW2, a third switch transistor TSW3, a second storage capacitor CST2, a fourth switch transistor TSW4, a driving transistor TD, a first light-emitting unit LED1, a second light-emitting unit LED2, a first light-emitting transistor TEM1, and a second light-emitting transistor TEM2. According to an embodiment of the disclosure, the pixel circuit 100 is implemented only by P-type transistors, but not intended to be limited thereto.

As shown in FIG. 1, the first switch transistor TSW1 is electronically connected to the driving transistor TD, in which there is a driving node ND between the first switch transistor TSW1 and the gate terminal of the driving transistor TD. The first switch transistor TSW1 is electrically connected to the third switch transistor TSW3, and there is a first node N1 in between. The first node N1 is electrically connected to the first switch transistor TSW1 and the third switch transistor TSW3, and the gate terminal of the first switch transistor TSW1 receives the first light-emitting signal EM1. The first storage capacitor CST1, which is electrically connected between the voltage source VDD and the first node N1, is configured to store the voltage of the first node N1. According to another embodiment of the disclosure, the first storage capacitor CST1 is electrically connected between the ground level VSS and the first node N1. According to another embodiment of the disclosure, the first storage capacitor CST1 may be electrically connected between any reference voltage and the first node N1.

Similarly, the second switch transistor TSW2 is electronically connected to the driving transistor TD, in which the second switch transistor TSW2 is electrically connected to the fourth switch transistor TSW4 and there is a second node N2 in between. The second node N2 is electrically connected to the second switch transistor TSW2 and the fourth switch transistor TSW4, and the gate terminal of the second switch transistor TSW2 receives the second light-emitting signal EM2. The second storage capacitor CST2, which is electrically connected between the voltage source VDD and the second node N2, is configured to store the voltage of the second node N2. According to other embodiments of the disclosure, the second storage capacitor CST2 may be electrically connected between any reference voltage and the second node N2.

The third switch transistor TSW3 is electrically connected between the first data signal DT1 and the first node N1, and the gate terminal of the third switch transistor TSW3 receives the scan signal SCN. The fourth transistor TSW4 is electrically connected between the second data signal DT2 and the second node N2, and the gate terminal of the fourth switch transistor TSW4 is electrically connected to the scan signal SCN.

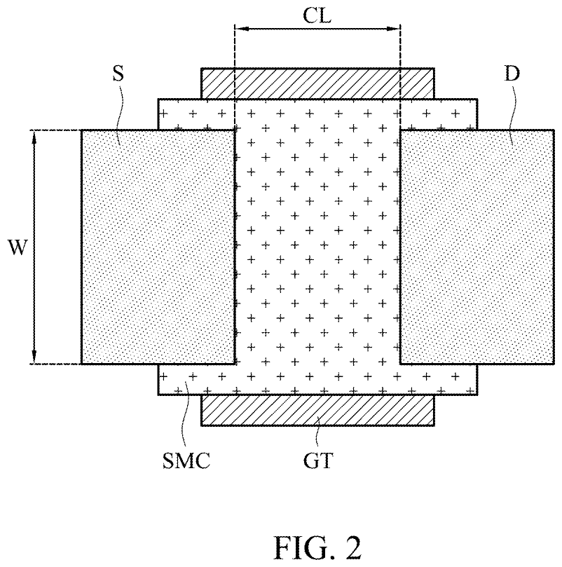

The driving transistor TD is electrically connected to the power source VDD, and the gate terminal of the driving transistor TD is electrically to the driving node ND. Therefore, the driving transistor TD controls the magnitude of the driving current based on the magnitude of the voltage of the driving node ND. FIG. 2 illustrates a transistor structure of a pixel circuit in accordance with an embodiment of the disclosure. Part of the semiconductor layer SMC of the transistor forms a channel region between the source region S and the drain region D. the gate terminal GT may be overlapped with the channel region in the looking-down direction. As shown in FIG. 2, the effective channel width of the channel region may be defined as a ratio of the width W of the channel region to the spacing CL of the channel region (W/CL). According to an embodiment of the invention, the driving transistor TD of the pixel circuit 100 is larger than any transistor of the pixel circuit 100. More specifically, the effective channel width of the driving transistor TD is far larger than that of any other transistors. For example, the ratio of the effective channel width of the driving transistor TD to the effective channel width of other transistor may be between 4 to 2000, i.e., 4≤ the effective channel width ratio≤2000.

According to some embodiments of the invention, the first light-emitting unit LED1 and the second light-emitting unit LED2 may include light-emitting diodes, such as organic light-emitting diodes (OLED), mini light-emitting diodes (mini-LED), micro light-emitting diodes (micro LED), quantum dot light-emitting diodes (QLED/QDLED) etc., or may include light source from quantum dots (QD), phosphors, or fluorescent material. However, the type of light-emitting unit is not intended to be limited thereto.

The first light-emitting transistor TEM1 is electronically connected between the driving transistor TD and the first light-emitting unit LED1, and the first light-emitting transistor TEM1 provides the driving current ID to the first light-emitting unit LED1 based on the first light-emitting signal EM1. The second light-emitting transistor TEM2 is electronically connected between the driving transistor TD and the second light-emitting unit LED2, and the second light-emitting transistor TEM2 provides the driving current ID to the second light-emitting unit LED2 based on the second light-emitting signal EM2. Namely, the first switch transistor TSW1 and the first light-emitting transistor TEM1 both receive the first light-emitting signal EM1, and the second switch transistor TSW2 and the second light-emitting transistor TEM2 both receive the second light-emitting signal EM2.

In other words, the first light-emitting unit LED1 and the second light-emitting unit LED2 in FIG. 1 share the same driving transistor TD. Since the effective channel width of the driving transistor TD in the pixel circuit 100 is far larger than the sum of the effective channel width of other transistors, the circuit layout area can be greatly reduced or the resolution of the display panel can be improved when the first light-emitting unit LED1 and the second light-emitting unit LED2 share the same driving transistor TD. It should be noted that two light-emitting units LED1, LED2 sharing the identical driving transistor TD is merely illustrated in the disclosure but not intended to be limited thereto. According to other embodiments of the disclosure, any number of light-emitting units can share the same driving transistor as well.

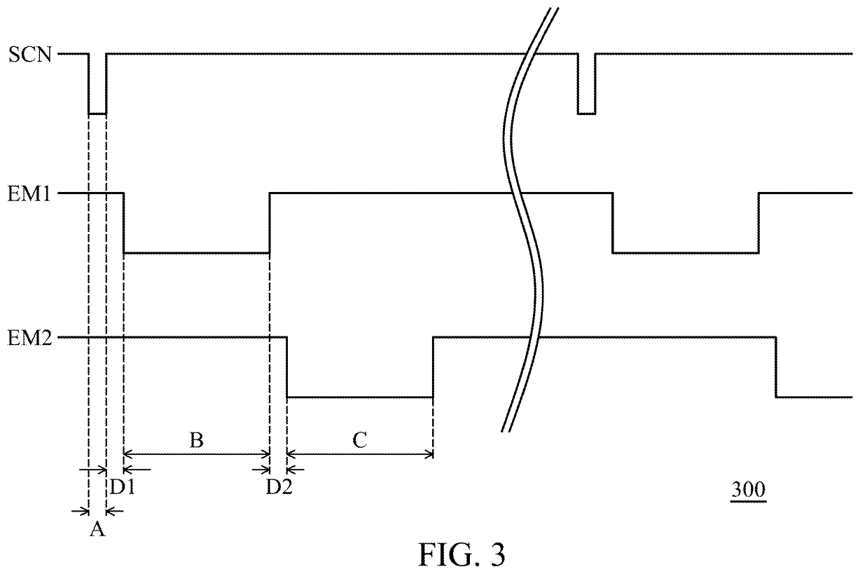

FIG. 3 illustrates a waveform diagram of the pixel circuit in FIG. 1 in accordance with an embodiment of the disclosure. The following description of the waveform diagram 300 in FIG. 3 will be accompanied with the pixel circuit 100 in FIG. 1 for better explanation.

As shown in FIG. 3, in the first period A, the scan signal SCN is in the low logic level. Therefore, the third switch transistor TSW3 and the fourth switch transistor TSW4 are turned ON based on the scan signal SCN in the low logic level, so that the first data signal DT1 is provided to the first node N1 through the third switch transistor TSW3 and the second data signal DT2 is provided to the second node N2 through the fourth switch transistor TSW4. In addition, the first storage capacitor CST1 stores the first data signal DT1 of the first node N1, and the second storage capacitor CST2 stores the second data signal DT2 of the second node N2.

As shown in FIG. 3, in the second period B, the scan signal SCN is in the high logic level, and the first light-emitting signal EM1 is in the low logic level. Therefore, the third switch transistor TSW3 and the fourth switch transistor TSW4 are turned OFF based on the scan signal SCN in the high logic level, and the first switch transistor TSW1 and the light-emitting transistor TEM1 are turned ON based on the first light-emitting signal EM1 in the low logic level. The first data signal DT1 stored in the first storage capacitor CST1 is provided to the driving node ND through the first switch transistor TSW1, and the driving transistor TD generates the driving current ID based on the first data signal DT1 provided to the driving node ND. The first light-emitting transistor TEM1 provides the driving current ID to the first light-emitting unit LED1 based on the first light-emitting signal EM1.

As shown in FIG. 3, there is a first delay time D1 between the second period B and the first period A, in which the first delay time D1 is not less than zero. In other words, the rising edge of the scan signal SCN in the first period A is synchronized with the falling edge of the first light-emitting signal EM1 in the second period B, or the rising edge of the scan signal SCN in the first period A occurs prior to the falling edge of the first light-emitting signal EM1 in the second period B. In other words, in a light-emitting cycle, the turn-on period of the third switch transistor TSW3 corresponding to the scan signal SCN occurs prior to the turn-on period of the first switch transistor TSW1 and the first light-emitting transistor TEM1 corresponding to the first light-emitting signal EM1. In addition, there is an interval between the turn-on period of the third switch transistor TSW3 and the turn-on period of the first switch transistor TSW1 (and/or the first light-emitting transistor TEM1).

As shown in FIG. 3, in the third period C, the scan signal SCN is in the high logic level, the first light-emitting signal EM1 is in the high logic level, and the second light-emitting signal EM2 is in the low logic level. Therefore, the third switch transistor TSW3 and the fourth switch transistor TSW4 are turned OFF based on the scan signal SCN in the high logic level, the first switch transistor TSW1 and the first light-emitting transistor TEM1 are turned OFF based on the first light-emitting signal EM1 in the high logic level, and the second switch transistor TSW2 and the second light-emitting transistor TEM2 are turned ON based on the second light-emitting signal EM2 in the low logic level. The second data signal DT2 stored in the second storage capacitor CST2 is provided to the driving node ND through the second switch transistor TSW2, the driving transistor TD generates the driving current ID based on the second data signal DT2 provided to the driving node ND, and the second light-emitting transistor TEM2 provides the driving current ID to the second light-emitting unit LED2 based on the second light-emitting signal EM2.

As shown in FIG. 3, there is a second delay time D2 between the third period C and the second period B, in which the second delay time D2 is not less than zero. In other words, the rising edge of the first light-emitting signal EM1 in the second period B is synchronized with the falling edge of the second light-emitting signal EM2 in the third period C, or the rising edge of the first light-emitting signal EM1 in the second period B occurs prior to the falling edge of the second light-emitting signal EM2 in the third period C.

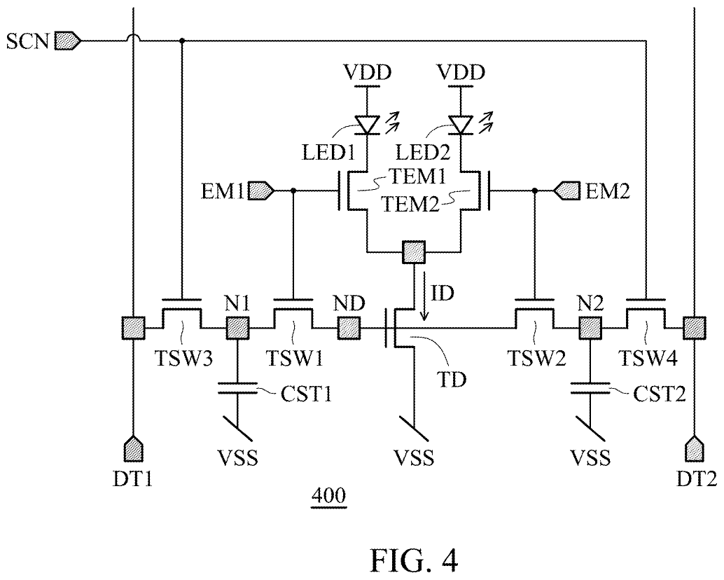

FIG. 4 is a schematic diagram of a pixel circuit in accordance with another embodiment of the disclosure, in which the architecture of the pixel circuit 400 is similar to that of the pixel circuit 100 in FIG. 1. The difference is that the pixel circuit 400 is implemented only by N-type transistors.

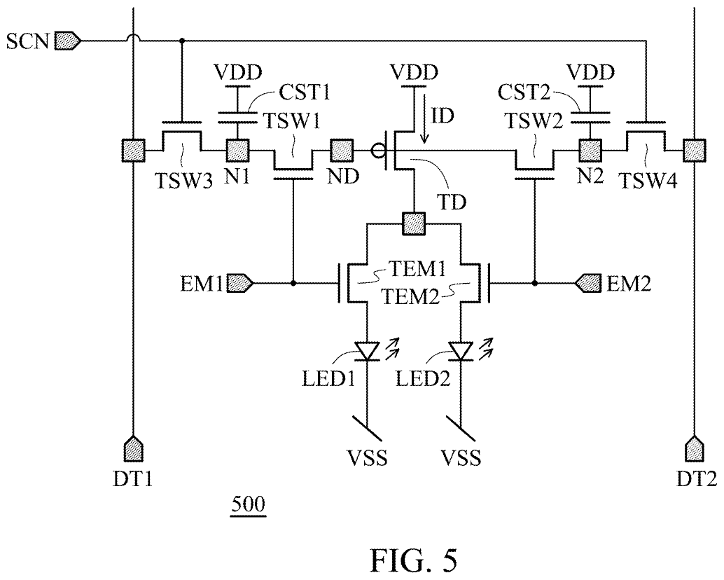

FIG. 5 is a schematic diagram of a pixel circuit in accordance with another embodiment of the disclosure. As shown in FIG. 5, the architecture of the pixel circuit 500 is similar to that of the pixel circuit 100 in FIG. 1. The difference is that the driving transistor TD of the pixel circuit 500 is implemented by a P-type transistor and other transistors are implemented by N-type transistors.

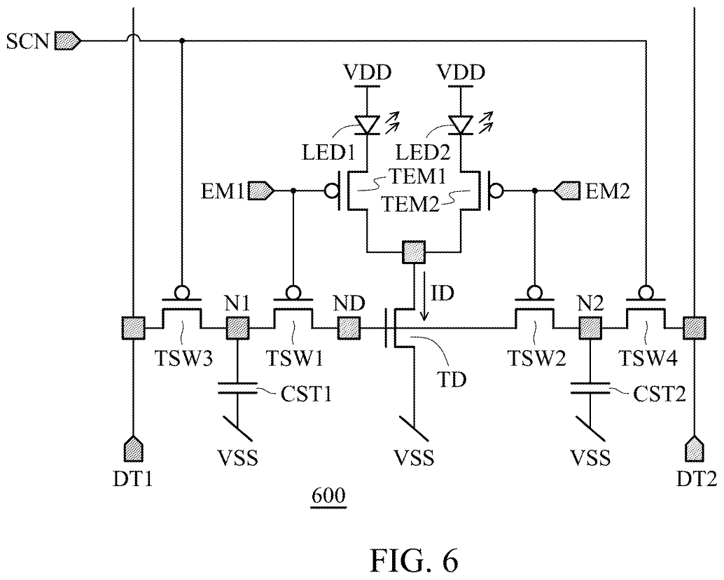

FIG. 6 is a schematic diagram of a pixel circuit in accordance with another embodiment of the disclosure. As shown in FIG. 6, the architecture of the pixel circuit 600 is similar to that of the pixel circuit 100 in FIG. 1. The difference is that the driving transistor TD of the pixel circuit 600 is implemented by an N-type transistor and other transistors are implemented by P-type transistors.

Since the pixel circuit 400 in FIG. 4, the pixel circuit 500 in FIG. 5, and the pixel circuit 600 in FIG. 6 are similar to the pixel circuit 100 in FIG. 1, one skilled in the art would perform a similar operation on the pixel circuit 400, the pixel circuit 500, and the pixel circuit 600 according to the pixel circuit 100 in FIG. 1 and the characteristics of N-type and P-type transistors. Therefore, the pixel circuit 400, the pixel circuit 500, and the pixel circuit 600 may have the identical functions of the pixel circuit 100 in FIG. 1, which will not be repeated herein. In addition, the type of each transistor of the pixel circuits in the disclosure is not intended to be limited to the embodiments illustrated in FIGS. 4-6.

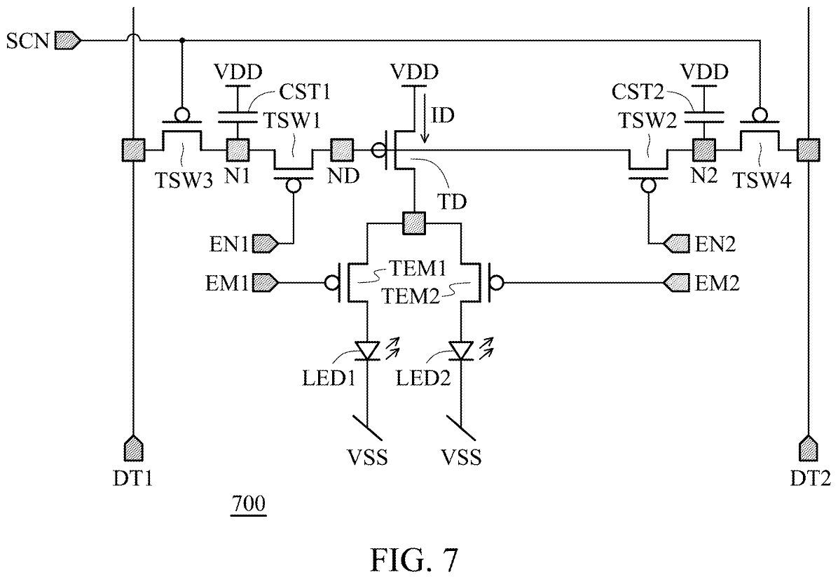

FIG. 7 is a schematic diagram of a pixel circuit in accordance with another embodiment of the disclosure. As shown in FIG. 7, the pixel circuit 700 includes a first switch transistor TSW1, a first storage capacitor CST1, a second switch transistor TSW2, a third switch transistor TSW3, a second storage capacitor CST2, a fourth switch transistor TSW4, a driving transistor TD, a first light-emitting unit LED1, a second light-emitting unit LED2, a first light-emitting transistor TEM1, and a second light-emitting transistor TEM2. According to an embodiment of the disclosure, the pixel circuit 700 is implemented only by P-type transistors.

The pixel circuit 700 in FIG. 7 is similar to the pixel circuit 100 in FIG. 1, so that the electrical connection between the elements in the pixel circuit 700 will not be repeated herein. The main difference between pixel circuit 700 and the pixel circuit 100 is that the first switch transistor TSW1 and the first light-emitting transistor TEM1 receive different signals, and the second switch transistor TSW2 and the second light-emitting transistor TEM2 receive different signals. More specifically, the gate terminal of the first switch transistor TSW1 receives the first enable signal EN1, and the gate terminal of the second switch transistor TSW2 receives the second enable signal EN2. The first light-emitting transistor TEM1 provides the driving current ID to the first light-emitting unit LED1 based on the first light-emitting signal EM1, and the second light-emitting transistor TEM2 provides the driving current ID to the second light-emitting unit LED2 based on the second light-emitting signal EM2.

Comparing the pixel circuit 700 in FIG. 7 with the pixel circuit 100 in FIG. 1, the timing for controlling the pixel circuit is more flexible since the first switch transistor TSW1 and the first light-emitting transistor TEM1 (or the second switch transistor TSW2 and the second light-emitting transistor TEM2) in the pixel circuit 700 are controlled by different signals.

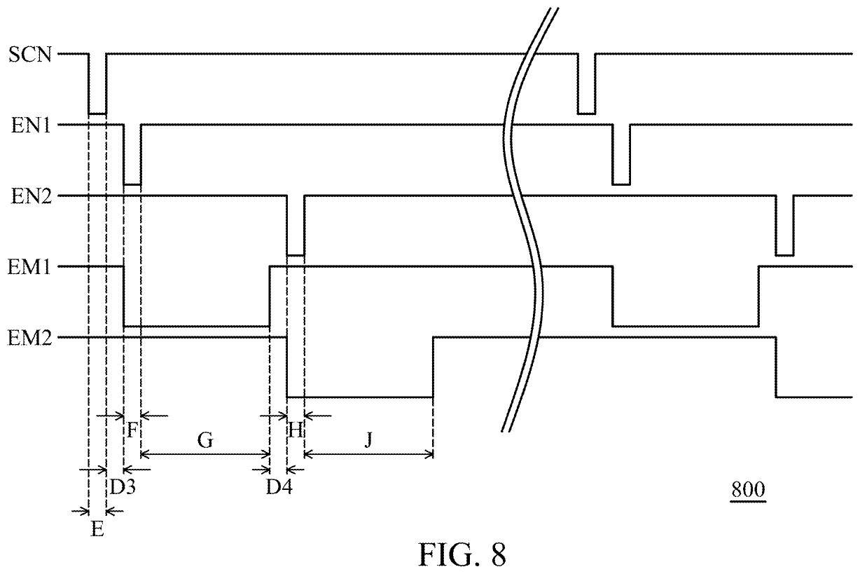

FIG. 8 illustrates a waveform diagram of the pixel circuit in FIG. 7 in accordance with an embodiment of the disclosure. The following description of the waveform diagram 800 in FIG. 8 will be accompanied with the pixel circuit 700 in FIG. 7 for better explanation.

As shown in FIG. 8, in the fourth period E, the scan signal SCN is in the low logic level, and the third switch transistor TSW3 and the fourth switch transistor TSW4 are turned ON based on the scan signal SCN in the low logic level. Therefore, the first data signal DT1 is provided to the first node N1 through the third switch transistor TSW3, and the second data signal DT2 is provided to the second node N2 through the fourth switch transistor TSW4. The first storage capacitor CST1 stores the first data signal DT1 at the first node N1, and the second storage capacitor CST2 stores the second data signal DT2 at the second node N2.

As shown in FIG. 8, in fifth period F, the scan signal SCN is in the high logic level, the first enable signal EN1 is in the low logic level, and the first light-emitting signal EM1 is in the low logic level. More specifically, the first enable signal EN1 and the first light-emitting signal EM1 transition from the high logic level to the low logic level. Therefore, the third switch transistor TSW3 and the fourth switch transistor TSW4 are turned OFF based on the scan signal SCN in the high logic level, the first switch transistor TSW1 is turned ON based on the first enable signal EN1 in the low logic level, and the first light-emitting transistor TEM1 is turned ON based on the first light-emitting signal EM1 in the low logic level. In other words, the turned-on period of the third switch transistor TSW3 corresponding to the scan signal SCN is prior to that of the first switch transistor TSW1 corresponding to the first enable signal EN1, and also prior to that of the first light-emitting transistor TEM1 corresponding to the first light-emitting signal EM1.

The first data signal DT1 stored in the first storage capacitor CST1 is provided to the driving node ND through the first switch transistor TSW1, and the driving transistor TD generates the driving current ID based on the first data signal DT1 provided to the driving node ND. In addition, the first light-emitting transistor TEM1 provides the driving current ID to the first light-emitting unit LED1 based on the first light-emitting signal EM1.

As shown in FIG. 8, there is a third delay time D3 between the fifth period F and the fourth period E, in which the third delay time D3 is not less than zero. In other words, the rising edge of the scan signal SCN in the fourth period E is synchronized with the falling edge of the first enable signal EN1 in the fifth period F, or the rising edge of the scan signal SCN in the fourth period E occurs prior to the falling edge of the first enable signal EN1 in the fifth period F.

As shown in FIG. 8, in the sixth period G, the first enable signal EN1 is in the high logic level, and the first light-emitting signal EM1 keeps in the low logic level. Therefore, when the first switch transistor TSW1 is turned OFF based on the first enable signal EN1 in the high logic level, the first data signal DT1 provided to the driving node ND through the first switch transistor TSW1 is stored in the parasitic capacitor of the driving transistor TD, so that the driving transistor TD generates the driving current ID based on the first data signal DT1 of the driving node ND and the driving current ID is provided to the first light-emitting unit LED1 through the first light-emitting transistor TEM1. It should be noted that, in some embodiments, an additional capacitor may be electrically connected to the driving transistor TD for storing the first data signal DT1 provided by the first switch transistor TSW1, so that the driving transistor TD still generates the driving current ID based on the first data signal DT1 of the driving node ND.

As shown in FIG. 8, in seventh period H, the scan signal SCN, the first enable signal EN1, and the first light-emitting signal EM1 are in the high logic level, and the second enable signal EN2 and the second light-emitting signal EM2 transition from the high logic level to the low logic level.

Therefore, the third switch transistor TSW3 and the fourth switch transistor TSW4 are turned OFF based on the scan signal SCN in the high logic level, the first switch transistor TSW1 is turned OFF based on the first enable signal EN1 in the high logic level, the first light-emitting transistor TEM1 is turned OFF based on the first light-emitting signal EM1 in the high logic level, the second switch transistor TSW2 is turned ON based on the second enable signal EN2 in the low logic level, and the second light-emitting transistor TEM2 is turned ON based on the second light-emitting signal EM2 in the low logic level.

The second data signal DT2 stored in the second storage capacitor CST2 is provided to the driving node ND through the second switch transistor TSW2, and the driving transistor TD generates the driving current ID based on the second data signal DT2 provided to the driving node ND. In addition, the second light-emitting transistor TEM2 provides the driving current ID to the second light-emitting unit LED2 based on the second light-emitting signal EM2.

As shown in FIG. 8, there is a fourth delay time D4 between the seventh period H and the sixth period G, in which the fourth delay time D4 is not less than zero. In other words, the rising edge of the first light-emitting signal EM1 of the sixth period G is synchronized with the falling edge of the second enable signal EN2 of the seventh period H and the falling edge of the second light-emitting signal EM2, or the rising edge of the first light-emitting signal EM1 of the sixth period G occurs prior to the falling edge of the second enable signal EN2 of the seventh period H and the falling edge of the second light-emitting signal EM2.

As shown in FIG. 8, in the eighth period J, the second enable signal EN2 is in the high logic level, and the second light-emitting signal EM2 remains in the low logic level. Therefore, when the second switch transistor TSW2 is turned OFF based on the second enable signal EN2 in the high logic level, the second data signal DT2 provided to the driving node ND through the second switch transistor TSW2 is stored in the parasitic capacitor of the driving transistor TD so that the driving transistor TD generates the driving current ID based on the second data signal DT2 of the driving node ND and the driving current ID is provided to the second light-emitting unit LED2 through the second light-emitting transistor TEM2.

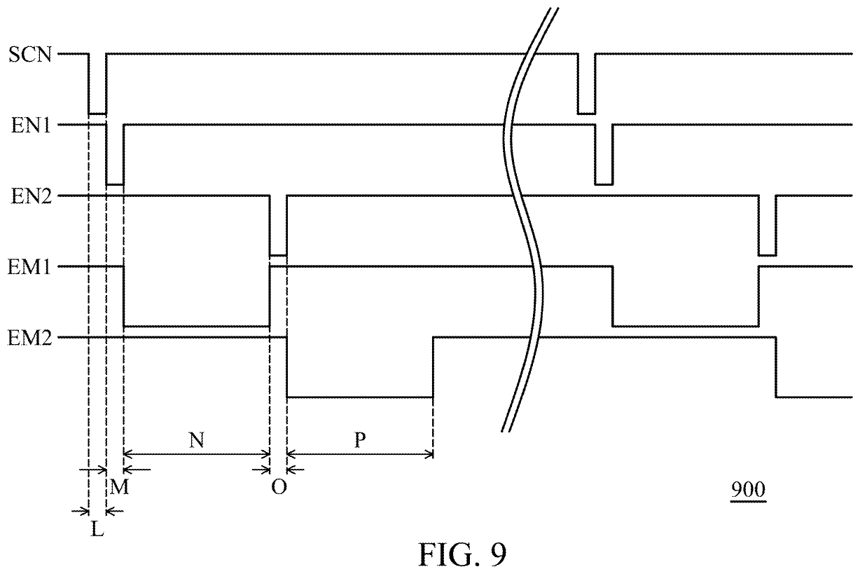

FIG. 9 illustrates a waveform diagram of the pixel circuit in FIG. 7 in accordance with another embodiment of the disclosure. The following description of the waveform diagram 900 in FIG. 9 will be accompanied with the pixel circuit 700 in FIG. 7 for better explanation.

As shown in FIG. 9, in the ninth period L, the scan signal SCN is in the low logic level so that the third switch transistor TSW3 and the fourth switch transistor TSW4 are turned ON based on the scan signal SCN in the low logic level. Therefore, the first data signal DT1 is provided to the first node N1 through the third switch transistor TSW3, and the second data signal DT2 is provided to the second node N2 through the fourth switch transistor TSW4. The first capacitor CST1 stores the first data signal DT1 at the first node N1, and the second storage capacitor CST2 stores the second data signal DT2 at the second node N2.

As shown in FIG. 9, in the tenth period M, the scan signal SCN is in the high logic level, the first enable signal EN1 is in the low logic level, and the first enable signal EN1 transitions from the high logic level to the low logic level when the scan signal SCN transitions from the low logic level to the high logic level. Therefore, the third switch transistor TSW3 and the fourth transistor TSW4 are turned OFF based on the scan signal SCN in the high logic level, and the first switch transistor TSW1 is turned ON based on the first enable signal EN1 in the low logic level. The first data signal DT1 stored in the first storage capacitor CST1 is provided to the driving node ND through the first switch transistor TSW1, and the driving transistor TD generates the driving current ID based on the first data signal DT1 provided to the driving node ND. It should be noted that even though, as shown in FIG. 9, the timing of the scan signal SCN transitioning from the low logic level to the high logic level is synchronized with that of the first enable signal EN1 transitioning from the high logic level to the low logic level, there may be a delay time between the transitioning timings of the scan signal SCN and the first enable signal EN1 as shown in FIG. 8 in accordance with some embodiments.

As shown in FIG. 9, in the eleventh period N, the first enable signal EN1 is in the high logic level, the first light-emitting signal EM1 is in the low logic level, and the first light-emitting signal EM1 transitions from the high logic level to the low logic level when the first enable signal EN1 transitions from the low logic level to the high logic level. Therefore, when the first switch transistor TSW1 is turned OFF based on the first enable signal EN1 in the high logic level, the first data signal DT1 provided to the driving node ND through the first switch transistor TSW1 is stored in the parasitic capacitor of the driving transistor TD so that the driving transistor TD generates the driving current ID based on the first data signal DT1 of the driving node ND. In addition, the first light-emitting transistor TEM1 provides the driving current ID to the first light-emitting unit LED1 based on the first light-emitting signal EM1. It should be noted that even though, as shown in FIG. 9, the timing of the first enable signal EN1 transitioning from the low logic level to the high logic level is synchronized with that of the first light-emitting signal EM1 transitioning from the high logic level to the low logic level, there may be a delay time between the transitioning timings of first enable signal EN1 and the first light-emitting signal EM1 in accordance with some embodiments. In addition, as shown in FIG. 9, in a light-emitting cycle, the turn-on time of the third switch transistor TSW3 corresponding to the scan signal SCN occurs prior to that of the first switch transistor TSW1 corresponding to the first enable signal EN1, and the turn-on time of the first switch transistor TSW1 occurs prior to that of the first light-emitting transistor TEM1 corresponding to the first light-emitting signal EM1.

As shown in FIG. 9, in the twelfth period O, the first light-emitting signal EM1 is in the high logic level, the second enable signal EN2 is in the low logic level, and the second enable signal EN2 transitions from the high logic level to the low logic level when the first light-emitting signal EM1 transitions from the low logic level to the high logic level. It should be noted that even though, as shown in FIG. 9, the timing of the first light-emitting signal EM1 transitioning from the low logic level to the high logic level is synchronized with that of the second enable signal EN2 transitioning from the high logic level to the low logic level, there may be a delay time between the transitioning timings of the first light-emitting signal EM1 and the second enable signal EN2 in accordance with some embodiments.

Therefore, the first light-emitting transistor TEM1 is turned OFF based on the first light-emitting signal EM1 in the high logic level and the second switch transistor TSW2 is turned ON based on the second enable signal EN2 in the low logic level, so that the second data signal DT2 stored in the second storage capacitor CST2 is provided to the driving node ND through the second switch transistor TSW2. The driving transistor TD generates the driving current ID based on the second data signal DT2 provided to the driving node ND.

As shown in FIG. 9, in thirteenth period P, the second enable signal EN2 is in the high logic level, the second light-emitting signal EM2 is in the low logic level, and the second light-emitting signal EM2 transitions from the high logic level to the low logic level when the second enable signal EN2 transitions from the logic level to the high logic level. Therefore, when the second switch transistor TSW2 is turned OFF based on the second enable signal EN2 in the high logic level, the second data signal DT2 provided to the driving node ND through the second switch transistor TSW2 is stored in the parasitic capacitor of the driving transistor TD so that the driving transistor TD still generates the driving current ID based on the second data signal DT2 of the driving node ND. In addition, the second light-emitting transistor TEM2 provides the driving current ID to the second light-emitting unit LED2 based on the second light-emitting signal EM2 in the low logic level. It should be noted that even though, as shown in FIG. 9, the timing of the first light-emitting signal EM1 transitioning from the low logic level to the high logic level is synchronized with that oft second enable signal EN2 transitioning from the high logic level to the low logic level, there may be a delay time between the transitioning timings of the first light-emitting signal EM1 and the second enable signal EN2 in accordance with some embodiments.

Comparing the waveform diagram 900 in FIG. 9 with the waveform diagram 800 in FIG. 8, the first light-emitting signal EM1 in FIG. 9 transitions from the high logic level to the low logic level after the first enable signal EN1 transitions from the high logic level to the low logic level. Similarly, the second light-emitting signal EM2 transitions from the high logic level to the low logic level after the second enable signal EN2 transitions from the high logic level to the low logic level. Therefore, when the driving transistor TD outputs the stable driving current ID based on the first data signal DT1 or the second data signal DT2, the first light-emitting transistor TEM1 or the light-emitting transistor TEM2 provides the driving current ID to the first light-emitting unit LED1 or the second light-emitting unit LED2 respectively so that the operation in the waveform diagram 900 leads to stability of the luminance of the light-emitting unit.

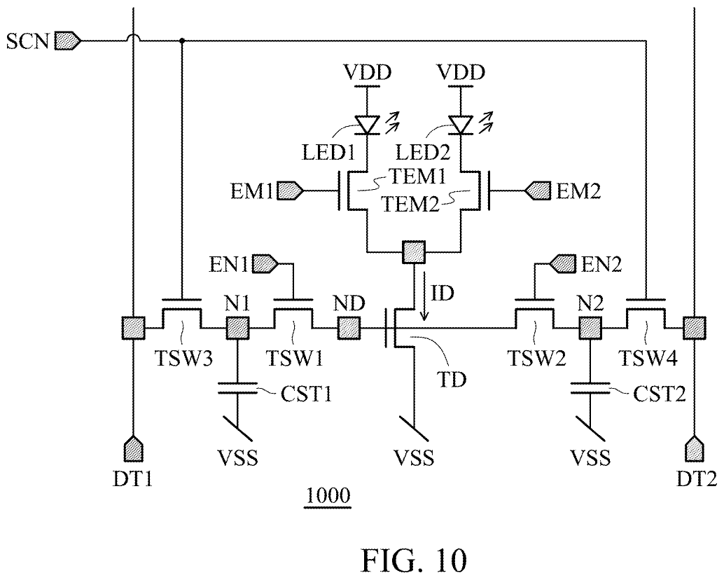

FIG. 10 is a schematic diagram of a pixel circuit in accordance with another embodiment of the disclosure. Comparing the pixel circuit 1000 in FIG. 10 with the pixel circuit 700 in FIG. 7, the pixel circuit 1000 is implemented only by N-type transistors. However, one skilled in the art would perform a similar operation on the pixel circuit 1000 according to the pixel circuit 700 in FIG. 7, the pixel circuit 800 in FIG. 8, the pixel circuit 900 in FIG. 9 and the characteristics of N-type and P-type transistors. Therefore, the pixel circuit 1000 has the identical functions of the pixel circuit 700 in FIG. 7, which will not be repeated herein. In addition, the type of each transistor of the pixel circuit in the disclosure is not intended to be limited to the embodiment illustrated in FIG. 10. In some embodiments, the pixel circuit may include one or more N-type transistors and one or more P-type transistors.

Electronic devices and pixel circuits are provided herein in the disclosure. The layout area of the overall pixel circuit can be reduced by a plurality of light-emitting units sharing the identical driving transistor.

In addition, by using different control signals to control the first switch transistor and the first light-emitting transistor (or, the second switch transistor and the second light-emitting transistor), it helps to improve the flexibility of controlling the pixel circuit. Moreover, the driving transistor can first generate the driving current based on the first data signal or the second data signal, and the driving current is then provided to the first light-emitting unit or the second light-emitting unit when the driving current is stable, thereby improving the stability of the luminance of the light-emitting unit.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An electronic device, comprising:
a substrate;
a first light-emitting unit, deposited on the substrate;
a second light-emitting unit, deposited on the substrate;
a driving transistor, electrically connected to a voltage source, wherein a gate terminal of the driving transistor is electrically connected to a driving node;
a first light-emitting transistor, electrically connected between the driving transistor and the first light-emitting unit; and
a second light-emitting transistor, electrically connected between the driving transistor and the second light-emitting unit.

2. The electronic device as defined in claim 1, further comprising:
a first switch transistor, electrically connected between the driving node and a first node;
a second switch transistor, electrically connected between the driving node and a second node;
a third switch transistor, electrically connected to the first node; and
a fourth switch transistor, electrically connected to the second node.

3. The electronic device as defined in claim 2, further comprising:
a first node, electrically connected to the first switch transistor and the third transistor; and
a second node, electrically connected to the second switch transistor and the fourth transistor;
wherein the third switch transistor provides a first data signal to the first node based on a scan signal, wherein the fourth switch transistor provides a second data signal to the second node based on the scan signal.

4. The electronic device as defined in claim 3, further comprising:
a first storage capacitor, electrically connected to the first node; and
a second storage capacitor, electrically connected to the second node.

5. The electronic device as defined in claim 2, wherein the first switch transistor and the first light-emitting transistor both receive a first light-emitting signal, and the second switch transistor and the second light-emitting transistor both receive a second light-emitting signal.

6. The electronic device as defined in claim 5, wherein a turn-on time of the third switch transistor is prior to a turn-on time of the first switch transistor.

7. The electronic device as defined in claim 6, wherein there is an interval between a turn-on time of the third switch transistor and a turn-on time of the first switch transistor.

8. The electronic device as defined in claim 2, wherein the first switch transistor and the first light-emitting transistor receive different signals.

9. The electronic device as defined in claim 2, wherein the second switch transistor and the second light-emitting transistor receive different signals.

10. The electronic device as defined in claim 8, wherein the turn-on time of the third switch transistor occurs prior to a turn-on time of the first switch transistor and a turn-on time of the first switch transistor is prior to a turn-on time of the first light-emitting transistor.

11. An electronic device, comprising:
a first light-emitting unit;
a second light-emitting unit;
a driving transistor, generating a driving current based on a voltage of a driving node;
a first switch transistor, providing a first data signal to the driving node;
a second switch transistor, providing a second data signal to the driving node;
a first light-emitting transistor, providing a first data signal to the first light-emitting unit based on a first light-emitting signal; and
a second light-emitting transistor, providing the driving current to the second light-emitting unit based on a second light-emitting signal.

12. The electronic device as defined in claim 11, further comprising:
a third switch transistor, electrically connected to the first node, wherein the third switch transistor provides a first data signal to the first node based on a scan signal; and
a fourth switch transistor, electronically connected to the second node, wherein the fourth switch transistor provides a second data signal to the second node based on the scan signal.

13. The electronic device as defined in claim 12, wherein the driving transistor, based on the first data signal or the second data signal, generates the driving current to drive the first light-emitting unit or the second light-emitting unit, wherein the first light-emitting transistor provides the driving current to the first light-emitting unit based on the first light-emitting signal, wherein the second light-emitting transistor provides the driving current to the second light-emitting unit based on the second light-emitting signal.

14. The electronic device as defined in claim 12, wherein after the third switch transistor provides the first data signal to the first node based on the scan signal and the fourth switch transistor provides the second data signal to the second node based on the scan signal, the first switch transistor provides the first data signal of the first node to the driving node based on the first light-emitting signal so that the driving transistor generates the driving current based on the first data signal, wherein the first light-emitting transistor further provides the driving current to the first light-emitting unit based on the first light-emitting signal.

15. The electronic device as defined in claim 14, wherein after the first light-emitting transistor provides the driving current to the first light-emitting unit based on the first light-emitting signal, the second switch transistor provides the second data signal of the second node to the driving node based on the second light-emitting signal so that the driving transistor generates the driving current based on the second data signal, wherein the second light-emitting transistor further provides the driving current to the second light-emitting unit based on the second light-emitting signal.

16. The electronic device as defined in claim 12, wherein after the third switch transistor provides the first data signal to the first node based on the scan signal and the fourth switch transistor provides the second data signal to the second node based on the scan signal, the first switch transistor provides the first data signal of the first node to the driving node based on a first enable signal so that the driving transistor generates the driving current based on the first data signal and the first light-emitting transistor simultaneously provides the driving current to the first light-emitting unit based on the first light-emitting signal.

17. The electronic device as defined in claim 16, wherein after the first light-emitting transistor simultaneously provides the driving current to the first light-emitting unit based on the first light-emitting signal, the second switch transistor provides the second data signal of the second node to the driving node based on a second enable signal and the second light-emitting transistor simultaneously provides the driving current to the second light-emitting unit based on the second light-emitting signal.

18. The electronic device as defined in claim 12, wherein after the third switch transistor provides the first data signal to the first node based on the scan signal and the fourth switch transistor provides the second data signal to the second node based on the scan signal, the first switch transistor provides the first data signal of the first node to the driving node based on a first enable signal so that the driving transistor generates the driving current based on the first data signal and the first light-emitting transistor then provides the driving current to the first light-emitting unit based on the first light-emitting signal.

19. The electronic device as defined in claim 18, wherein after the first light-emitting transistor simultaneously provides the driving current to the first light-emitting unit based on the first light-emitting signal, the second switch transistor provides the second data signal of the second node to the driving node based on a second enable signal and the second light-emitting transistor then provides the driving current to the second light-emitting unit based on the second light-emitting signal.

20. The electronic device as defined in claim 11, further comprising:
a first storage capacitor, electrically connected to the first node; and
a second storage capacitor, electrically connected to the second node.
